(19) United States
(12) Patent Application Publication
(10) Pub. No.: US 2012/0025472 A1
(43) Pub. Date: Feb. 2, 2012

(54) LABYRINTH SEAL

(76) Inventors: Wilhelm Reiter, (US); Christos Georgakis, (US); Ivan Ramirez, Nottingham (GB); Venkatesan Palaniappan, Rugby (GB)

(21) Appl. No.: 13/111,102

(22) Filed: May 19, 2011

(30) Foreign Application Priority Data
May 28, 2010 (GB) 1008968.8

(51) Int. Cl. F16J 15/44; F16J 15/447

(52) U.S. Cl. 277/355; 277/412

(57) ABSTRACT

A labyrinth seal has a plurality of arcuate labyrinth seal segments 14 in which the confronting ends of adjacent arcuate labyrinth seal segments 14 have planar faces 26 which are oriented radially and axially but which are canted away from a strictly axial orientation 28 by a cant angle. A plurality of arcuate brush seal segments 16 may be retained in the plurality of arcuate labyrinth seal segments 14, thereby forming a combined labyrinth and brush seal.

This application claims priority under 35 U.S.C. §119 to Great Britain Application No. 1008968.8, filed 28 May 2010, the entirety of which is incorporated by reference herein.

### BACKGROUND

1. Field of Endeavor

The present disclosure relates to a labyrinth seal, and in particular to a labyrinth seal for sealing between static and rotating parts in a gas turbine or steam turbine. Embodiments relate to a combined labyrinth and brush seal.

2. Brief Description of the Related Art

Labyrinth seals are commonly used to provide a seal between static and rotating parts in an axial flow turbine such as a gas turbine or steam turbine. Typically, a labyrinth seal is formed by a plurality of arcuate labyrinth seal segments. The arcuate labyrinth seal segments may also carry a plurality of arcuate brush seal segments, thereby forming a combined labyrinth and brush seal.

Conventional labyrinth seals can suffer from a number of problems including leakage at the confronting ends of adjacent arcuate labyrinth seal segments and vibration within the seal as a result of relative movement between adjacent arcuate labyrinth seal segments.

There is, therefore, a need for an improved labyrinth seal.

### SUMMARY

According to a first aspect, a labyrinth seal includes a plurality of arcuate labyrinth seal segments, wherein confronting ends of adjacent arcuate labyrinth seal segments have planar faces which are oriented radially and axially but which are canted away from a strictly axial orientation by a cant angle.

By canting the radially and axially oriented planar faces of confronting ends of adjacent arcuate labyrinth seal segments away from a strictly axial orientation, additional frictional forces arise between adjacent arcuate labyrinth seal segments, thereby damping the relative movement between adjacent arcuate labyrinth seal segments and reducing vibration within the labyrinth seal.

The cant angle may be between about one degree and six degrees.

In preferred embodiments, the cant angle is between two degrees, plus or minus one degree, and five degrees, plus or minus one degree. A minimum cant angle of about two degrees may be appropriate because the manufacturing tolerances are typically plus or minus one degree and because a cant angle of less than one degree may have little or no effect on reducing vibration. A maximum cant angle of about five degrees may be appropriate because, taking into account the aforesaid manufacturing tolerances, a cant angle of greater than six degrees may result in unacceptably large frictional forces between the confronting ends of adjacent arcuate labyrinth seal segments, thereby resulting in an unacceptably stiff labyrinth seal.

The labyrinth seal may include a plurality of arcuate brush seal segments retained in the plurality of arcuate labyrinth seal segments, thus forming a combined labyrinth and brush seal.

Each arcuate brush seal segment typically includes an arcuate bristle retainer and a plurality of bristles which are retained by the arcuate bristle retainer and typically inclined away from the radial direction of the labyrinth seal. Confronting ends of the arcuate bristle retainers of adjacent arcuate brush seal segments are typically inclined away from the radial direction, at substantially the same angle of inclination as the bristles. This ensures that there are no triangular gaps between the bristles at the confronting ends of adjacent arcuate brush seal segments.

The confronting ends of the arcuate bristle retainers of adjacent arcuate brush seal segments are preferably axially oriented, usually in a strictly axial orientation.

Each arcuate brush seal segment typically has the same angular extent as the arcuate labyrinth seal segment which retains it. Each arcuate labyrinth seal segment typically comprises a plurality of axially spaced arcuate fins which normally have the same angular extent as the arcuate labyrinth seal segment. The labyrinth seal normally forms part of the static structure of a gas turbine or steam turbine and cooperates with a radially adjacent rotating surface. Typically, the arcuate brush seal segments and fins extend from an inner surface of each arcuate labyrinth seal segment towards a radially adjacent rotating surface.

### BRIEF DESCRIPTION OF THE DRAWINGS

The invention of the present application will now be described in more detail with reference to exemplary embodiments of the apparatus and method, given only by way of example, and with reference to the accompanying drawings, in which:

FIG. 1 is a diagrammatic perspective view of part of an embodiment of a combined labyrinth and brush seal in a disassembled state showing confronting ends of adjacent seal ring segments;

FIG. 2 is a diagrammatic radially inward looking view on the radially outer surface of an arcuate labyrinth seal segment of FIG. 1; and

FIGS. 3 and 4 are simplified radially inward looking and axial views of the seal segments shown in FIG. 1 after assembly, showing the regions of contact between confronting ends of adjacent arcuate seal segments.

### DETAILED DESCRIPTION OF EXEMPLARY EMBODIMENTS

Embodiments will now be described by way of example only and with reference to the accompanying drawings.

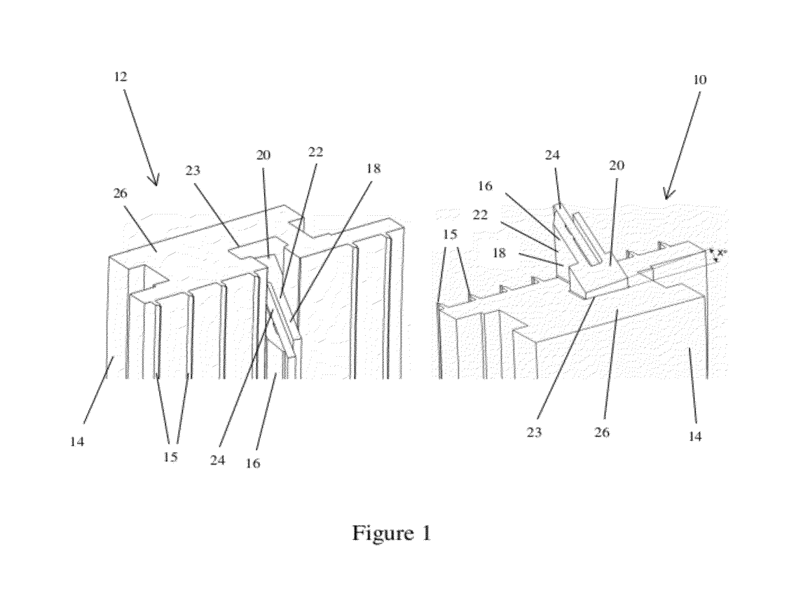

FIG. 1 is a perspective view of the confronting ends of two adjacent seal ring segments 10, 12 of a labyrinth seal. In order to form a complete labyrinth seal, it will be understood that a plurality of the seal ring segments 10, 12 are arranged end-to-end to form a continuous seal ring. The labyrinth seal forms part of the static structure of a gas turbine or a steam turbine and cooperates with a radially adjacent rotating surface so that a seal is formed between the static and rotating parts.

Each seal ring segment 10, 12 includes an arcuate labyrinth seal segment 14 having fins 15 which extend from a radially inner surface of the arcuate labyrinth seal segment 14 towards the surface of a radially adjacent rotating part (not shown). It is common practice to utilize labyrinth seals whose sealing elements include only fins 15 or the like, as described above. However, in the present case, a combined labyrinth and brush seal is formed by retaining arcuate brush seal segments 16 in the arcuate labyrinth seal segments 14. It is preferred that each arcuate brush seal segment 16 has the same angular extent as a corresponding arcuate labyrinth seal segment 14. The arcuate brush seal segments 16 reduce leakage and thereby increase the sealing efficiency of the labyrinth seal.

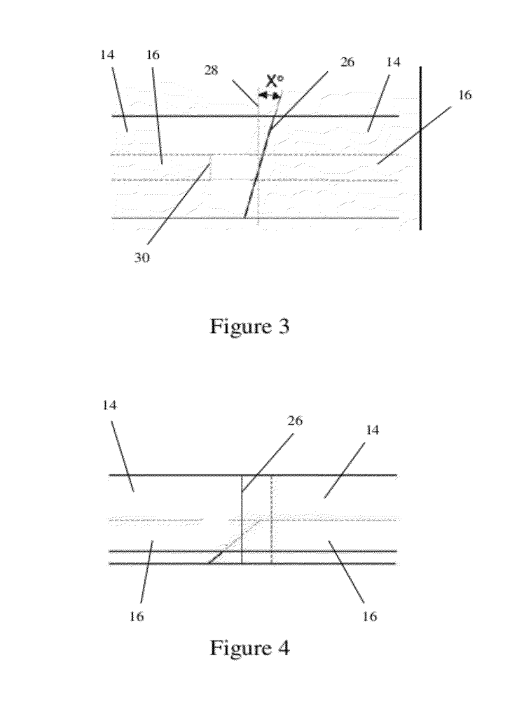

The arcuate brush seal segment 16 has an arcuate bristle retainer 18 which has a generally T-shaped cross-section, and the head 20 or cross-bar of the T-shaped bristle retainer 18 and most of its stem 22 are located in a correspondingly shaped slot 23 in the arcuate labyrinth seal segment 14. The end of the arcuate bristle retainer 18 is oriented axially (i.e., is not inclined away from the strictly axial direction), as best shown by the dashed line 30 in FIG. 3. A plurality of bristles 24 are retained by the arcuate bristle retainer 18 and the bristles 24 are inclined away from the radial direction of the labyrinth seal at a common angle, for example 45 degrees, so that if notionally extended beyond their length, they would be nominally tangential to a circle of smaller diameter than the labyrinth seal.

In order to avoid a triangular gap between the bristles 24 at confronting ends of the adjacent arcuate brush seal segments 16, which would leave the bristles 24 adjacent the triangular gap unsupported by neighboring bristles and therefore liable to damage, the confronting ends of the arcuate bristle retainers 18 of adjacent arcuate brush seal segments 16 are also inclined away from the radial direction of the labyrinth seal at the same angle of inclination as the bristles 24. As a result, the end of one of the arcuate brush seal segments 16 projects from the end face of the seal ring segment 10 whilst the confronting end of the adjacent arcuate brush seal segment 16 is recessed inwardly from the end face of the seal ring segment 12.

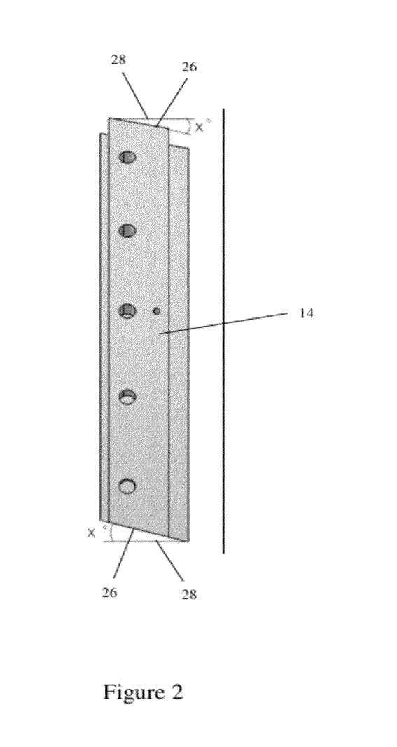

The confronting end of each adjacent arcuate labyrinth seal segment 14 has a generally planar face 26 which is oriented in the radial and axial directions of the labyrinth seal. The generally planar face 26 of the confronting end of each adjacent arcuate labyrinth seal segment 14 is oriented in a strictly radial direction, as best seen in FIG. 4, but is canted away from a strictly axial orientation, denoted by the line 28 in FIGS. 2 and 3, by a cant angle x. As discussed above, this increases the frictional forces between the confronting ends of adjacent arcuate labyrinth seal segments 14, thereby increasing damping and reducing unwanted vibration which can otherwise arise in the labyrinth seal during operation of a gas turbine or steam turbine.

In typical embodiments, the cant angle x is between about 2 and 5 degrees, these minimum and maximum cant angles being subject to a typical manufacturing tolerance of about ±1 degree. As discussed above, a cant angle x of less than about 1 degree is believed to have little or no effect on reducing vibration whilst a cant angle x of greater than about six degrees is believed to result in an unacceptably stiff seal as a result of unacceptably large frictional forces.

Although various embodiments have been described in the preceding paragraphs, it should be understood that various modifications may be made to those embodiments without departing from the scope of the following claims. For example, the arcuate brush seal segments 16 (when present) could have any suitable configuration, possibly having confronting ends that are not inclined away from the radial direction.

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

We claim:

1. A labyrinth seal comprising:
a plurality of arcuate labyrinth seal segments having ends, wherein confronting ends of adjacent arcuate labyrinth seal segments have planar faces which are oriented radially and axially and which are canted away from an axial orientation by a cant angle.

2. A labyrinth seal according to claim 1, wherein the cant angle is between about one and six degrees.

3. A labyrinth seal according to claim 1, wherein the cant angle is between two and five degrees, plus or minus one degree.

4. A labyrinth seal according to claim 1, further comprising:
a plurality of arcuate brush seal segments retained in the plurality of arcuate labyrinth seal segments.

5. A labyrinth seal according to claim 4, wherein each arcuate brush seal segment comprises an arcuate bristle retainer and a plurality of bristles retained by the arcuate bristle retainer.

6. A labyrinth seal according to claim 5, wherein:
the arcuate bristle retainers comprise ends;
the bristles are inclined away from the radial direction of the labyrinth seal; and
confronting ends of the arcuate bristle retainers of adjacent arcuate brush seal segments are inclined away from the radial direction, at substantially the same angle of inclination as the bristles.

7. A labyrinth seal according to claim 5, wherein:
the arcuate bristle retainers comprise ends; and
confronting ends of the arcuate bristle retainers of adjacent arcuate brush seal segments are axially oriented.

8. A labyrinth seal according to claim 4, wherein each arcuate brush seal segment has the same angular extent as the corresponding arcuate labyrinth seal segment which retains it.
